(19) United States
(12) Patent Application Publication
(10) Pub. No.: US 2012/0144816 A1
(43) Pub. Date: Jun. 14, 2012

(54) Method for Operating a Pneumatic System and Pneumatic System

(75) Inventor: Rijk Jan Van Dongen, Gorinchem (NL)

(73) Assignee: Q PLUS BEHEER B.V., Sliedrecht (NL)

(21) Appl. No.: 13/383,502

(22) PCT Filed: May 26, 2010
(86) PCT No.: PCT/EP2010/057257

§ 371 Date: Feb. 29, 2012

(30) Foreign Application Priority Data
Jul. 23, 2009 (EP) 09166270.0

(51) Int. Cl. F15B 11/16

(52) U.S. Cl. 60/327; 60/484

(57) ABSTRACT

Method for operating a pneumatic system comprising at least one pneumatic cylinder, the method comprising: supplying a first gas under pressure to a pneumatic cylinder for a first stroke, wherein the first stroke is a working stroke of said cylinder, and; providing a second gas under pressure, wherein the pressure of the second gas is lower than the pressure of the first gas, wherein providing the second gas comprises providing the first gas from the pneumatic cylinder during a second stroke of said pneumatic cylinder.

The present invention relates to a method for operating a pneumatic system comprising at least one pneumatic cylinder. The invention further relates to a pneumatic system comprising at least one cylinder. The invention furthermore relates to the various components of said pneumatic system.

Compressed air is the most expensive energy carrier in the industry and it is accepted that roughly 15-20% of the industrial use of electricity is spent on generating this compressed air. Long time the perception in the market was that compressed air is “for free” but today lobbies for energy conservation and CO2 emission reduction, make perfectly clear there is a lot of energy/money saving possible in generating, transporting and using compressed air.

Historically, pneumatic control systems often use over-dimensioned piston cylinders which have room for energy conserving by lowering working pressures, still able to deliver enough forces as the pneumatic system requires. The tendency of last decades in the development of control valves is integration of functions and miniaturizing dimensions and flow paths. This results in pressure losses in pneumatic systems of which the market is not aware. Awareness is growing that energy can be saved in pneumatic systems. However the level of technology offered to the market is low and not higher than leak seeking and leak repair.

Reduction of pressures per point of use, and reduction of pressures losses in pneumatic systems, offers large room for improvement for the efficiency in pneumatic equipment. Lowering system pressures however will have the disadvantage that the reaction times and cycle times of piston cylinders increase and the pneumatic systems get slower, thus looses efficiency. Reduction of pressure by means of a pressure regulator will always lead to energy losses and has the disadvantage that is done with air which was brought to high pressure level first, at considerable energy costs.

WO 2006/0366118 describes a pneumatic system comprising a high pressure system and a low-pressure system both set by pressure regulators from the same excess pressure source. The high pressure system pressure will act within a working chamber of a (single acting, air spring returned) piston cylinder during the working stroke of the cylinder arrangement by means of a 3/2 valve connected to both the working port over the high-pressure regulator and the piston cylinder return port over the low-pressure regulator. The low pressure system is acting as a counter-pressure, (air spring) being compressed by the piston movement during the working stroke due to the high-pressure system pressure, thus creating increasing low-pressure system pressure. To prevent excessive pressurizing an accumulator tank can be used by increasing the volume of the low-pressure system volume. Any further excessive pressure of the low pressure system due to compression is exhausted to the atmosphere by a safety valve to prevent the excessive loss of force due to high counter pressure from the low-pressure system pressure. After the high-pressure air of the working chamber is exhausted to the atmosphere over the 3/2 valve during the return stroke the always remaining low-pressure system (because its exhaust is blocked by a non-return valve) will return the piston. In case the low-pressure falls below a set point due to the volume increase of the low-pressure system volume caused by the piston movement, low pressure system air is fed into the low-pressure system over a pre set low-pressure regulator from the express pressure source.

It is a goal of the current invention, amongst others goals, to provide an energy efficient method for operating a pneumatic system comprising at least one pneumatic cylinder.

The above goal is met by the present invention, amongst other goals, by method for operating a pneumatic system as defined in the appended claim 1.

Specifically, the above goal, amongst other goals, is met by the present invention by a method for operating a pneumatic system comprising at least one pneumatic cylinder, the method comprising:
supplying a first gas under pressure to a pneumatic cylinder for a first stroke, wherein the first stroke is a working stroke of said cylinder, and;
providing a second gas under pressure, wherein the pressure of the second gas is lower than the pressure of the first gas,
   wherein providing the second gas comprises providing the first gas from the pneumatic cylinder during a second stroke of said pneumatic cylinder. According to the invention, gas that has been used in a working stroke is reused as second gas, instead of exhausting said gas to the open air as is common in the art.

Since the gas used for a working stroke still has residual pressure after performing said working stroke, the gas provided or collected from the cylinder, the second gas, can be used for other purposes, for instance for operating a pump or realising a cylinder return stroke. It will be appreciated that by reusing the first gas, an energy efficient method for operating a pneumatic system is provided according to the invention. The present invention allows energy reductions in a pneumatic system from 25% up to over 50%.

The first gas used for a working stroke is provided or collected during the subsequent stroke, wherein the first gas used for the working stroke is collected for providing the second gas. Providing the second gas preferably comprises providing the first gas from the pneumatic cylinder from a previous working stroke of said pneumatic cylinder.

Preferably, providing the second gas comprises supplying the first gas from the pneumatic cylinder to an accumulator vessel in the second stroke. In a stroke following a working stroke, the first gas is supplied from the cylinder to the accumulator vessel for storage of said gas as the second gas. Providing the second gas thereby preferably comprises exhausting the first gas from a pneumatic cylinder during a stroke following a working stroke to said accumulator vessel. More preferably, supplying the gas from the cylinder to the accumulator vessel comprises supplying the gas through a non-return valve for preventing flow of gas from the accumulator vessel back to the cylinder during said second stroke.

A preferred embodiment of the method according to the invention comprises supplying the first gas to a pneumatic cylinder for the second stroke, wherein said second stroke is a working stroke, wherein providing the second gas furthermore comprises providing the first gas from said pneumatic cylinder during the first stroke of said pneumatic cylinder. In this embodiment, both the first and the second strokes of the pneumatic cylinder are working strokes. For performing these working strokes, the high pressure first gas is supplied to the cylinder in both the first and second stroke. This also allows providing or reclaiming the second gas during both strokes. During the second stroke, the gas used for the first working stroke is provided as second gas, whereas in the first stroke, the gas is collected from the cylinder which was used in the previous working stroke, i.e. the second stroke.

It should be noted that with a first and a second stroke, the two subsequent strokes in a pneumatic cylinder cycle are meant. As an example, the first stroke can be an outstroke and the second stroke can be an instroke or vice versa. With a working stroke a stroke is meant wherein the pneumatic cylinder is arranged to do work (i.e. deliver force over a distance), i.e. move an object. This in contrast to a returning stroke, wherein the pneumatic cylinder does not work, or wherein the work is at least substantially less than in a working stroke. In general, a returning stroke returns a piston of the pneumatic cylinder to the initial position for the next working stroke, without doing any substantial work.

The pressure of the first gas is preferably between approximately 4 and 10 bar, more preferably between approximately 6 and 8 bar. This allows efficient working strokes for a pneumatic cylinder. The pressure of the second gas is preferably between approximately 1.5 and 3 bars and more preferably the pressure of the second gas is approximately 2 bar. Said second gas can be efficiently recuperated from the first gas, while still providing sufficient pressure for a returning stroke of a pneumatic cylinder.

A further preferred embodiment of the method according to the invention comprises supplying the second gas to a pneumatic cylinder for the second stroke, wherein said second stroke is a returning stroke. Since the pneumatic cylinder does less work in a returning stroke, the second gas can be used for performing the second stroke being a returning stroke. This results in a very efficient returning stroke, since the first gas used in the previous working stroke can be used to perform the returning stroke. According to the invention, high pressure gas used for a working stroke is recuperated and used for a returning stroke. This realizes substantial energy savings.

For the working stroke of the cylinder, the first gas is supplied to the cylinder, allowing the cylinder to do work. For the second stroke being a returning stroke, the second gas is supplied, wherein said second gas is provided from the first gas from said pneumatic cylinder during the previous working stroke of said pneumatic cylinder.

Preferably, the second gas for the returning stroke is supplied from the accumulator vessel to the cylinder, preferably over a control valve. The second gas stored in said accumulator vessel can then be used for performing a returning stroke of a cylinder. The second gas in the accumulator vessel can for instance at least partially be supplied by another pneumatic cylinder performing two working strokes in a cycle.

However, it is also advantageously if supplying the second gas comprises supplying the first gas from the pneumatic cylinder to said pneumatic cylinder for the returning stroke. The gas used for a working stroke is then redirected back to said pneumatic cylinder directly for performing the returning stroke.

More preferably, the second gas for the returning stroke is supplied from both the accumulator vessel, preferably over a control valve, and the cylinder itself. Supplying the second gas for the returning stroke using two conduits, results in lower pressure drops. Since the accumulator vessel is preferably filled with the first gas from said cylinder, high pressure gas used in the working stroke is supplied to said cylinder via both the accumulator vessel and the direct line.

According to a further preferred embodiment of the method according to the invention, in a working stroke the first gas is supplied to the pneumatic cylinder through a working line, wherein providing the second gas during the second stroke comprises switching a working valve to at least partially seal of said working line from the pneumatic cylinder to provide the second gas, preferably to provide the second gas to the accumulator vessel and/or the pneumatic cylinder for the returning stroke. In the first stroke, a working stroke, the working valve supplies the first gas from the working line to the pneumatic cylinder. During a second stroke, the working line is at least partially sealed of allowing the gas from said pneumatic cylinder to be directed to for instance the accumulator vessel for providing said second gas.

The invention further relates to a pneumatic system comprising:
at least one pneumatic cylinder, wherein the pneumatic cylinder is arranged to perform a first stroke and a second stroke, wherein the first stroke is a working stroke;
at least one first gas source for providing a first gas under pressure;
at least one second gas source for providing a second gas under pressure, wherein the pressure of the second gas is lower than the pressure of the first gas;
at least one switching device for switching the supply of gas to the pneumatic cylinder, wherein the switching device is arranged to supply the first gas to the pneumatic cylinder for the first stroke and to supply the first or the second gas to the pneumatic cylinder for the second stroke, and;
at least one working valve, wherein the working valve is arranged to supply the first gas to the pneumatic cylinder in the first stroke and to supply the first gas from the pneumatic cylinder to the second gas source in the second stroke.

According to the invention, a pneumatic system is provided wherein gas used for a working stroke in a pneumatic cylinder can de recuperated or provided using a working valve. In a working stroke, the first gas from the first gas source is switched to the working valve and the working valve is arranged to supply the first gas to said pneumatic cylinder. During a subsequent stroke, the working valve is arranged to redirect the first gas from said pneumatic cylinder to the second gas source and preferably the working valve is arranged to exhaust the first gas from the pneumatic cylinder during the second stroke to the second gas source. For preventing flow of gas back from the second gas source to the pneumatic cylinder during the second stroke, at least one non-return valve can be provided.

Preferably the working valve comprises a speed regulator for regulating the gas flow from said working valve to the switching device while exhausting the first gas to the second gas source. This allows the speed of the second stroke to be controlled.

According to a preferred embodiment of the pneumatic system according to the invention, the second gas source comprises an accumulating vessel, wherein the working valve is arranged to supply the first gas from a working stroke of a pneumatic cylinder to the accumulating vessel in the second stroke. The accumulating vessel is arranged to hold the second gas provided from a pneumatic cylinder. The working valve extends between the pneumatic cylinder and the accumulating vessel and is arranged to switch the flow of gas from said cylinder to the accumulator vessel for filling said vessel.

According to a further preferred embodiment of the pneumatic system according to the invention, the switching device comprises a working outlet and a second outlet, wherein the working outlet is arranged to supply the first gas to the pneumatic cylinder in the working stroke and wherein the second outlet is arranged to supply the first or second gas to the pneumatic cylinder in the second stroke, wherein the working valve is arranged between the working outlet and the pneumatic cylinder. The switching device comprises two outlets, allowing an easy connection of a pneumatic cylinder provided with two ports with said switching device. At least between the working outlet and the port of the pneumatic cylinder for supply of gas for the working stroke, the working valve is arranged.

According to a further preferred embodiment of the pneumatic system according to the invention, the working valve comprises:
a working port arranged for connection with the switching device;
a cylinder port arranged for connection with the cylinder, and;
at least one second gas port arranged for connection with the second gas source,
   wherein the working valve is arranged to supply gas to the cylinder port upon supply of gas under pressure on the working port and to otherwise supply at least a part of the gas from the cylinder port to the second gas port, wherein the working valve furthermore preferably comprises a speed regulator for regulating the flow of gas from the cylinder port back to the working port. The working valve is hereby arranged to direct gas from the working port to the cylinder port when a gas under pressure is supplied to said working port. In a working stroke, the first gas is therefore supplied to the pneumatic cylinder. Preferably, upon a drop of pressure on the working port, for instance due to exhaustion, the working valve is arranged to direct gas from the cylinder port to the second port. This allows the first gas from the cylinder to be directed to the second gas source. The speed regulator controls the speed of the gas leaving the pneumatic cylinder through the working port back to the switching device, thereby controlling the speed of the second stroke. More preferably, the working valve comprises a floating seal for sealing of the second port upon supply of gas under pressure on the working port.

More preferably the second gas port comprises a non-return valve. This prevents the flow of gas from the second gas source back into for instance the cylinder.

According to a further preferred embodiment of the pneumatic system according to the invention, the switching device comprises a low pressure switching device arranged to supply the second gas to the pneumatic cylinder in a second stroke, wherein the second stroke is a returning stroke. This switching device is used for pneumatic cylinders only having one working stroke, wherein the other stroke is a returning stroke. By using the second gas from the second gas source, for instance the accumulator vessel, for this returning stroke, an energy efficient pneumatic cycle is obtained, since the second gas comprises recuperated first gas.

Preferably the second gas source comprises a connecting line, wherein the working valve is arranged to supply the first gas from the pneumatic cylinder through the connecting line to said pneumatic cylinder for the second stroke. The connecting line extends between the working valve and the second port of the cylinder. In the second stroke, gas used for the working stroke is supplied through the connecting line to the second port of the pneumatic cylinder for the second stroke. Via the first port of the pneumatic cylinder, a second port of the working valve and the connecting line, the first gas is supplied to the second port of the pneumatic cylinder. Preferably the working valve hereto comprises two second ports, one for supplying gas to the accumulating vessel and one to supply gas directly to the pneumatic cylinder for the second stroke.

More preferably, the pneumatic system further comprises a returning valve, wherein the returning valve is arranged to supply the second gas from said connecting line and the gas from the low pressure switching device to the pneumatic cylinder, wherein the returning valve comprises a speed regulator for regulating the flow of gas from the pneumatic cylinder through said valve in the first stroke. Regulating the outflow of gas from said cylinder in the first stroke allows regulating the speed of the first stroke. In the second stroke, the second gas is supplied from both the switching device and the connecting line, decreasing pressure drops of the second gas.

According to a further preferred embodiment of the pneumatic system according to the invention, the switching device comprises a high pressure switching device which is arranged to supply the first gas to the pneumatic cylinder in a second stroke, wherein the second stroke is a working stroke, wherein two working valves are arranged to supply first gas from the working strokes to the second gas source. The high pressure switching device is arranged to supply high pressure gas for both the strokes of the pneumatic cylinder. By providing a working valve between both outlets of the switching device and the ports of the pneumatic cylinders, second gas can be provided in both strokes according to the invention.

A further preferred embodiment of the pneumatic system according to the invention comprises a switching system comprising a plurality of switching devices, preferably at least one low pressure switching device and at least one high pressure switching device, for switching gas to a plurality of pneumatic cylinders. By providing for instance one high pressure switching device and one low pressure switching device in a switching system, a versatile pneumatic system is provided. Pneumatic cylinders operating with two working strokes can be connected to the high pressure switching device, while a pneumatic cylinder having one working stroke and a returning stroke can be connected to the low pressure switching device. Second gas recuperated from the pneumatic cylinder connected to the high pressure switching device can then be used in the low pressure switching device for a returning stroke.

It should be noted that the high pressure switching device is arranged to only provide the first gas, while the low pressure switching device is arranged to supply both the first and the second gas to a pneumatic cylinder, based on the type of gas needed for a particular stroke. The high pressure switching device hereto comprises at least two pressure lines, one for the first gas and one for exhaustion, while the low pressure switching device comprises at least three pressure lines, one for the first gas, one for the second gas and one exhaust line. Preferably the number of pressure lines for the high pressure switching device and the low pressure switching device is equal, wherein the pressure lines are formed integral and wherein preferably a seal is provided in the pressure lines to separate the pressure lines from the high and low pressure switching devices. This results in a compact composition.

It will be appreciated that the present invention offers a ready to use solution to implement a number of energy saving control valves (switching device) to replace conventional use control valves without changing the existing pneumatical lay out by adding any other pneumatic control valves. An existing pneumatic system can therefore readily be adjusted into a pneumatic system according to the invention.

A further preferred embodiment of the pneumatic system according to the invention comprises a connection system, wherein the connection system is arranged to connect the pneumatic system to a control terminal arranged to control the pneumatic system, wherein the connection system comprises a plurality of first poles for connection with the pneumatic system for control thereof and a plurality of second poles for connection with the control terminal, wherein the connection system furthermore comprises at least one connecting device for removable connecting at least one first pole with at least one second pole, wherein the connecting device preferably comprises a conducting wire. Using the connection system, an existing pneumatic system can be easily adapted to a pneumatic system according to the invention. It is therefore easy to electrically connect the energy saving system according to the invention to the original controls of the pneumatic system.

The present invention therefore offers a ready to use solution to implement a number of energy saving control valves and conventional use control valves without changing the existing electrical controls for these control valves.

The invention furthermore relates to a switching device and/or switching system and/or working valve and/or returning valve and/or connection system for use in the pneumatic system according to the invention.

The present invention is further illustrated by the following Figures, which show a preferred embodiment of the device according to the invention, and are not intended to limit the scope of the invention in any way, wherein:

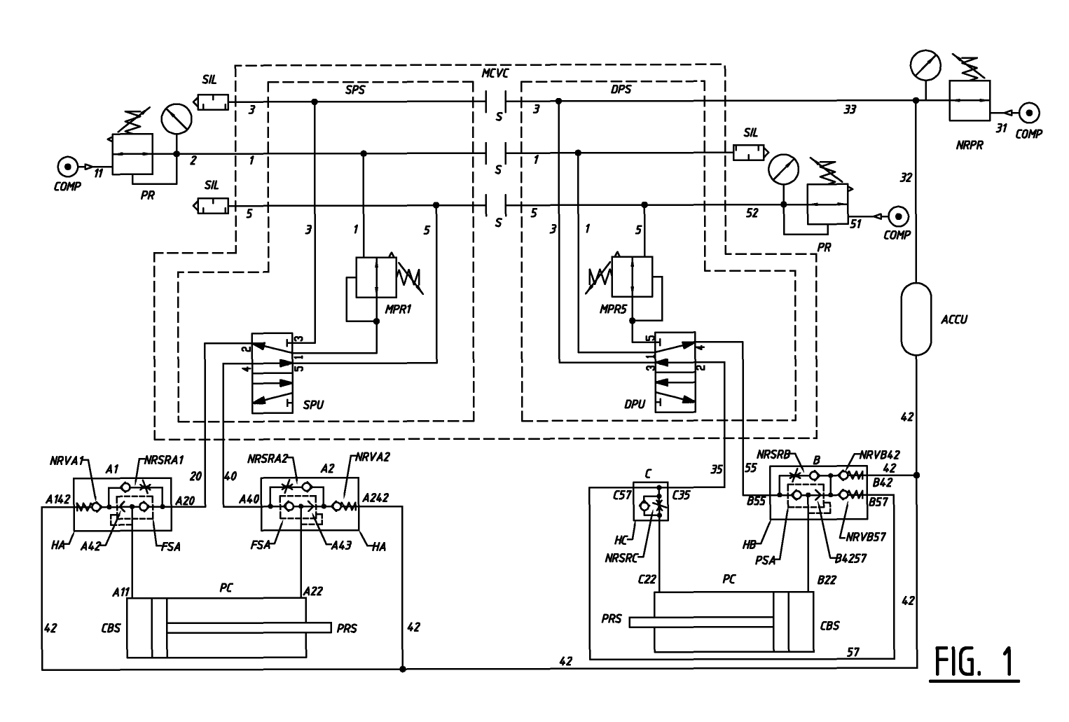

FIG. 1 shows a pneumatic diagram of the pneumatic system according to the invention, and;

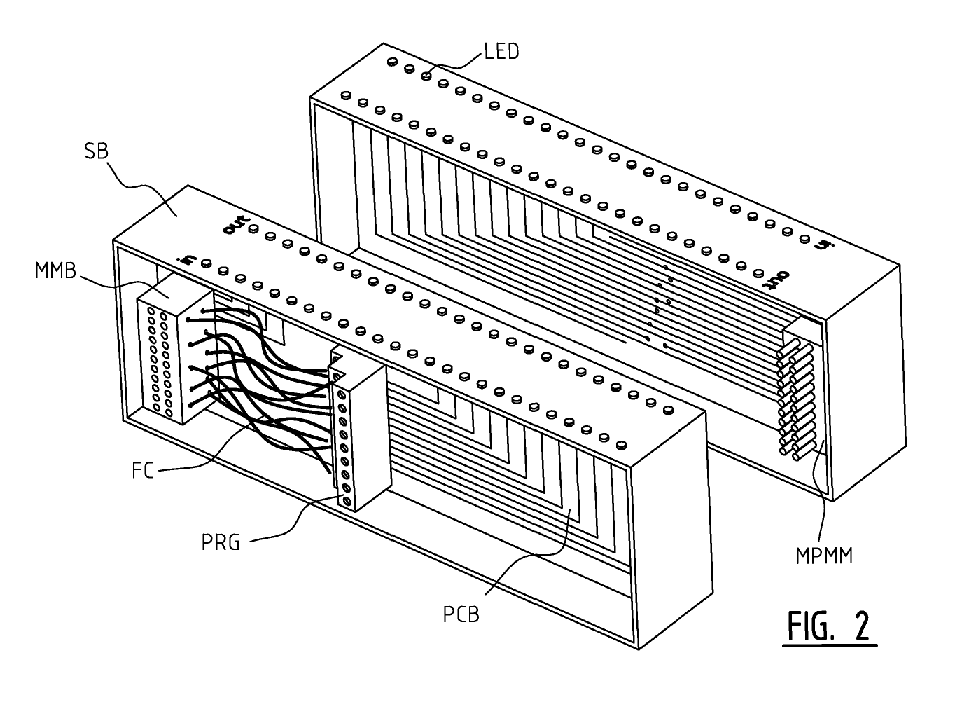

FIG. 2 schematically shows a connecting device according to the invention.

With reference to FIG. 1, the present invention is an energy saving and conserving pneumatic control system for the control of pneumatic piston-cylinders, comprising minimally two and optionally three pressures connected to the compressed air system, connected to a multiple control valve configuration MCVC. The manifold MCVC comprises a modular manifold with 3 common ports with conduits 1, 3 and 5 and two ports with conduits 2 and 4 per individual control valve, and comprising of control valves for single pressure use SPU and control valves for double pressure use DPU mounted modularly on top of said modular manifold. Said valves SPU and DPU have corresponding ports to said modular manifold. The compressed air system is a system with excess pressure and volume of compressed air. High pressure can be regarded as a compressed air system of 4-10 bar, low pressure as a compressed air system of 1.5 tot 3 bar.

A control valve can be a solenoid operated control valve, a pneumatic operated control valve or any form of manual or mechanical control valve. Present invention will have several nominal sizes in order to be able to work with several different piston cylinder diameters.

The invention is intended for industrial use and shall often be used as a modular manifold with control valves. However, present invention also includes mounting of control valves with the use of a manifold, mounted directly into a system of conduits/plastic tubing.

Said modular manifold MCVC is configured into a single pressure section SPS wherein conduit 1 is carrying high pressure and conduit 5 and 3 are used for exhausting compressed air from the said single pressure valve SPU.

Said modular manifold MCVC also comprises a double pressure section DPS in which said conduit 1 is used for exhausting compressed air, and conduit 5 is carrying high pressure compressed air, and conduit 3 is carrying low pressure air. Said conduits 1, 3 and 5 are inside the modular manifold and divided by means of a seal S to allow for division of the conduits into said different sections. Ports 2 and 4 are for individually connecting said control valves SPU and DPU to a corresponding number of piston-cylinders. The number and type of control valves can be chosen according the pneumatic system.

Said modular manifold MCVC is also includes modular electrical connections allowing quick connection of the electrical control signals which switch the control valves SPU and DPU. Electrical signals for said control valves can be connected centrally to the said modular manifold by multipole as well as field bus connectors.

Said single pressure valves SPU are generally from the 5 port 2 position model 5/2 either monostable or bistable due to the one or two electrical control elements mounted on these 5/2 valves. The pressure from conduit 1 in the single pressure section SPS is connected to port 1 of said control valve SPU, pressure exhaust ports from conduits 3 and 5 to ports 3 and 5 of said control valve SPU and ports 2 and 4 of said control valve SPU are connected to conduits 40 and 20 for connecting with the piston cylinder.

Said double pressure valves DPU are generally from the 5 port 2 position model 5/2 either monostable or bistable due to the one or two electrical control elements mounted on these 5/2 valves. The high pressure from conduit 5 in the double pressure section is connected to port 5 of said control valve. Conduit 1 in the double pressure section is used for exhausting from port 1 of said double pressure valve DPU in the double pressure section, and conduit 3 is connected to port 3 of said double pressure valve DPU for feeding low pressure into said double pressure control valve. Port 2 and 4 of said control valve DPU valve are connected respectively to conduits 35 and 55 for connection with the piston cylinder. Optionally the same function from the 5/2 valve can be obtained by using two 3 port 2 position 3/2 valves, or four 2 port 2 position 2/2 valves.

### Use of Single Pressure Section

Port 1 of conduit 1 in the said single pressure section SPS of the said modular manifold MCVC is connected to the system pressure COMP by a conduit 11 leading to a pressure regulator PR where system pressure is set to the desired high pressure for said single pressure section SPS, and from said pressure regulator connected by conduit 12 to said port 1 into conduit 1.

High pressure level is related to the maximum needed actuating force of any of the piston-cylinders PC connected to the single pressure section SPS. Port 3 and 5 of conduit 3 and conduit 5 of the said single pressure section SPS are used for exhausting system pressure coming from the single pressure control valves SPU when they are switching position. Conduits 3 and 5 are covered by a pneumatic silencer SIL for reduction of noise and ingress of dirt.

Piston-cylinders which need high actuating forces for both stroke directions inwards or outwards, are connected to the said single pressure control valves SPU mounted in the said single pressure section SPS. Optionally said single pressure control valves SPU can be equipped with a modular pressure regulator on port 1 MPR1 mounted between said modular manifold MCVC and said single pressure control valve SPU for further reduction of pressure given to an individual piston-cylinder PC.

The connection of said single pressure control valves SPU is made by conduit 20 from port 2 on the said modular manifold MCVC to port A20 of a speed regulating-quick exhaust valve A1 mounted on the bottom side CBS of said piston-type cylinder PC by port A11 on said speed regulating quick exhaust valve A1, and by a conduit 40 from port 4 of said single pressure valve SPU to port A40 of a second speed regulating-quick exhaust valve A2 mounted on the piston rod side PRS of said piston-type cylinder PC by port A22. Speed regulating-quick exhaust valve A1 and A2 are the same components and they are used on piston-cylinders which need high actuating forces for both stroke directions inwards or outwards and therefore used in combination with single pressure section SPS.

The speed regulating-quick exhaust valve A1 comprises a housing HA with a floating seal FSA allowing air flow from it ports A20 into the housing HA from where it flows into port A11 in housing HA into the cylinder bottom side of the piston cylinder. Meanwhile, the floating seal FSA is closing off port A42 inside said housing HA thus preventing high pressure air to leave the housing HA and flow out over port A42 into port A142 into conduit 42 to the accumulator tank ACCU filled with low pressure air.

Housing HA also comprises a non-return valve NRVA1 in port A142 for conduit 42 to prevent air from the accumulator tank ACCU to flow back into the piston cylinder bottom side chamber over port A11. Furthermore it comprises a non return speed regulator NRSRA1 to regulate piston speed during exhaust of the compressed air from the cylinder bottom section by regulating exhaust air flowing back to the control valve SPU over conduit 20 via port A20.

### Switching the Single Pressure Control Valve, Cylinder Moves Outwards

When said control valve SPU is switched electrically to move the piston of said piston-cylinder PC to the piston rod side PRS, compressed air is transferred from said control valve SPU port 2 through conduit 20 into the speed regulating-quick exhaust valve A1 port A20. It passes floating seal FSA entering piston cylinder port A11.

Simultaneously said control valve SPU is exhausting air through port 4 and conduit 40 into conduit 5 of the modular manifold MCVC. This causes floating seal FSA from regulating-quick exhaust valve A2 to lift from its port A43 position and open to port A242 thus enabling the compressed air from the piston rod chamber of said cylinder to exhaust over the non-return valve NRVA2 from port A242 into conduit 42 and flow into pressure vessel ACCU. The exhausting from the high pressure compressed air from the piston-cylinder will cause the air to accumulate in the pressure vessel ACCU where it builds a low pressure compressed air volume for reuse. To minimize pressure loss during exhausting sizes of conduit 42 will have a bigger diameter than conduit 20 and 40.

When the pressure difference between said piston rod chamber PRC of said cylinder PC and said pressure vessel ACCU is equalized, said non return valve NRVA2 will close due to light spring force. After closing of the non return valve NRVA2 the remaining air of the piston rod chamber of said cylinder can exhaust through a non return speed regulating device NRSRA2 assembled into said regulating-quick exhaust valve A2. This non return speed regulating device controls in this way the speed of the piston while moving towards the piston rod side PRS of the piston cylinder.

### Switching the Single Pressure Control Valve SPU Back, Cylinder Moves Inwards

When said control valve SPU is switched electrically again to move the piston of said piston-cylinder PC towards the cylinder bottom side CBS, compressed air is transferred from said control valve SPU port 4 through conduit 40 into the regulating-quick exhaust valve A2 port A40. It passes floating seal FSA entering piston cylinder port A22 meanwhile closing off port A43 to prevent high pressure air flowing over non return valve NRVA2 to port A242 from there filling the pressure vessel ACCU with high pressure. Simultaneously said control valve SPU is exhausting air through port 2 and conduit 20 into conduit 3 of the modular manifold MCVC. This causes floating seal FSA from regulating-quick exhaust valve A1 to lift from its position and open port A42 making the compressed air flow from the bottom cylinder side to exhaust over the non-return valve NRVA1 to port A142 into conduit 42 and flow into pressure vessel ACCU.

The exhausting from the high pressure compressed air from the cylinder bottom section CBS will cause the air to accumulate in the pressure vessel ACCU where it builds a low pressure compressed air volume for reuse. To minimize pressure loss during exhausting sizes of conduit 42 will have a bigger diameter than conduit 20 and 40.

When the pressure difference between said the cylinder bottom chamber CBS of said cylinder PC and said pressure vessel ACCU is equalized, said non return valve NRVA1 will close due to light spring force. After closing of the non return valve NRVA1 the remaining air of the piston rod chamber of said cylinder can now exhaust through a non return speed regulating device NRSRA1 assembled into said regulating-quick exhaust valve A1. This non return speed regulating device NRSRA1 controls in this way the speed of the piston while moving towards the cylinder bottom side CBS of the piston cylinder.

After a full cycle the piston cylinder as used in the single pressure section SPS has exhausted twice its high pressure compressed air volume into the accumulator vessel ACCU creating a volume of reusable compressed air of low pressure. Due to the placing of said non return valves NRVA1 and NRVA2 the conduit 42 works as part of the accumulator vessel. Momentary pressure levels created by this exhausting high pressure compressed air are depending on the pneumatic system lay out, like number and sizes of the piston cylinders, sequence of actuating the piston cylinders and the volume of the accumulator vessel ACCU. A calculation program will be provided on internet to make a step by step calculation of the momentary pressure levels following the working sequence of the pneumatic system.

### Switching of the Double Pressure Control Valve

Port 5 of conduit 5 of the said double pressure section DPS of the said modular manifold MCVC is connected to the system pressure COMP by a conduit 51 leading to a pressure regulator PR where pressure is set to the desired pneumatic high pressure for said double pressure section DPS, and from said pressure regulator PR by a conduit 52 to said port 5. Desired high pressure is based on the maximum needed actuating force of the piston-cylinders PC connected to the double pressure section DPS. Port 1 of conduit 1 of the said double pressure section DPS is used for exhausting pressure to the open air and is covered by a pneumatic silencer SIL for reduction of noise and ingress of dirt. Port 3 of conduit 3 of the said double pressure section DPS of the said modular manifold is connected to the system pressure COMP by a conduit 31 leading to a non relieving pressure regulator NRPR where pressure is set to the desired low pneumatic pressure for said double pressure section DPS, and from said pressure regulator by a conduit 32 to an accumulator vessel ACCU of system dependant volume and by a conduit 33 to said port 3.

Desired pressure on port 3 is based on the needed lowest return force of the piston-cylinders PS connected to the double pressure section DPS. Note that accumulator vessel ACCU and its conduit 32 and conduit 33 are connected to conduit 42 this way forming a greater storage vessel. The regulator must be of a non-relieving nature because the accumulator vessel ACCU will be filed with high pressure compressed air, therefore pressure will rise in said accumulator vessel ACCU. This pressure increase represents conserved energy and must not be exhausted over the pressure regulator but used for the piston cylinder low pressure strokes.

Piston-cylinders which accept low pressure for the return stroke are connected to the said double pressure control valves DPU on the said double pressure section DPS. Said double pressure control valves DPU are used on the double pressure section DPS. Optionally said double pressure section DPS can be equipped with a modular pressure regulator on port 5 MPR5 mounted between said modular manifold MCVC and said double pressure control valve DPU for further reduction of pressure given to an individual piston-cylinder PC.

The connection of said double pressure control valves DPU to the piston cylinders is made by conduit 55 from port 4 on the said modular manifold MCVC to a speed regulating-quick exhaust valve B mounted on the bottom side CBS of said piston-type cylinder PC and by a conduit 35 from port 2 of said double pressure control valve DPU to a speed regulating-valve C mounted on the piston rod side PRS of said piston-type cylinder PC.

Speed regulating-quick exhaust valve B and C are used on piston-cylinders which need high actuating pressure for one piston cylinder stroke and one low actuating pressure stroke and therefore used in combination with double pressure section DPS. The low pressure side of the piston cylinder is equipped with the non-return speed control valve C and the high pressure side of the piston cylinder with speed regulating-quick exhaust valve B.

The speed regulating-quick exhaust valve B comprises a housing HB with a floating seal FSA allowing air flow from it ports B55 into the housing HB from where is flows into port B22 in housing HB into the cylinder bottom side of the piston cylinder. Meanwhile the floating seal FSA of quick exhaust valve B inside said housing HB is closing off ports B4257 thus preventing high pressure air to leave the housing HB and flow out over port B42 into conduit 42 to the accumulator tank ACCU filled with low pressure air and port B57 to conduit 57 of speed regulating valve C. Housing HB also comprises two non-return valves NRVB42 and NRVB57. Non return valve NRVB42 is connected to port B42 and conduit 42 to prevent air from the accumulator tank ACCU to flow into the piston cylinder BOTTOM side chamber. Non return valve NRVB57 is connected by port B57 to conduit 57 and is preventing air from speed regulating valve C to flow into the cylinder bottom side. Furthermore speed regulating-quick exhaust valve B comprises a non return speed regulator NRSRB to regulate piston speed during exhaust of the compressed air from the cylinder piston rod side by regulating exhaust air flowing back over port B55 to conduit 55 the to control valve DPU.

The speed regulating valve C comprises a housing HC with a non return speed regulator NRSRC in order to control the piston speeds when said piston is moved towards the piston rod side of the piston cylinder and air is exhausting of port C22 to port C35 and conduit 35. It also comprises a port C57 for conduit 57 which connects to port B57 on the speed regulating-quick exhaust valve B.

### Switching the Single Pressure Control Valve

When said control valve DPU is switched electrically to move the piston of said piston-cylinder PC to the piston rod side PRS, compressed air is transferred from said control valve DPU port 4 through conduit 55 into the regulating-quick exhaust valve B port B55. It passes floating seal FSA entering piston cylinder port B22.

Simultaneously said control valve DPU is exhausting air through port 2 and conduit 35 into conduit 1 on the double pressure side DPS of the modular manifold MCVC. This enables the compressed air from the piston rod chamber of said cylinder to exhaust from port C22 over the non-return speed control valve C to port C35 into conduit 35 and flow through conduit 1 of the double pressure side DPS of the modular manifold MCVC to exhaust passing silencer SIL. Conduit 57 will also be exhausted over conduit 35.

### Switching the Single Pressure Control Valve Back

When said control valve DPU is switched electrically again to move the piston of said piston-cylinder PC to the cylinder bottom side CBS, compressed air is transferred from said control valve DPU port 2 through conduit 35 into the non return speed regulating valve C port C35. It passes the non return valve for rapid filling of the piston rod section of the cylinder with low pressure air from the accumulator vessel ACCU.

Simultaneously said control valve DPU is exhausting air from port 4 and conduit 55 into conduit 1 on the double pressure side of the modular manifold MCVC. This causes floating seal FSA from regulating-quick exhaust valve B to lift from its position and open port B4257 thus enabling the compressed air from the cylinder bottom chamber CBS of said cylinder to exhaust over the non-return valve NRVB42 into port B42 and conduit 42 where the high pressure compressed air will accumulate in the pressure vessel ACCU where it builds a low pressure compressed air volume for reuse. Also from port B4257 the compressed air from the cylinder bottom chamber CBS of said cylinder will exhaust over the non-return valve NRVB57 into port B57 and into conduit 57 and flows over port C57 directly into non return speed regulator C in this way assisting the pressurizing of the piston rod chamber with high pressure air and keeping the cylinder reaction times low and filling speed high.

To minimize pressure loss during exhausting, the sizes of conduits 42 and 57 will have a bigger diameter than conduit 35 and 55. Air passing non return valve B57 flows over port B57 into conduit 57 and flows over port C57 directly into non return speed regulator C in this way assisting the pressurizing of the piston rod chamber with high pressure air and keeping the cylinder reaction times low and filling speed high.

When the pressure difference between said cylinder bottom chamber CBS of said cylinder PC and said pressure vessel ACCU is equalized said non return valve NRVB42 will close due to light spring force. When the pressure difference between said the cylinder bottom chamber CBS of said cylinder PC and said piston rod chamber PRS is equalized said non return valve NRVB57 will close due to light spring force.

After closing of the non return valves NRVB42 and NRVB57 the remaining air of the cylinder bottom chamber of said cylinder can exhaust over the non return speed regulating device NRSRB assembled into said regulating-quick exhaust valve B. This non return speed regulating device controls in this way the speed of the piston while moving towards the cylinder bottom side CBS of the piston cylinder

After a full cycle the piston cylinder in section DPS has exhausted once into the accumulator vessel ACCU creating a volume of reusable compressed air of low pressure. Also in a full cycle the piston cylinder is moved one stroke by low pressure air generated from high pressure air, not costing any extra electric energy for generating this low pressure air.

This way an energy efficient return stroke is generated where in common systems a high pressure return stroke was used, thus generating a 50% saving on this piston cylinder control.

In case an existing pneumatic system is adapted to implement the energy conserving valve concept, all piston cylinders in the machine will be equipped with the speed regulating-quick exhaust valves A1, A2 and B, and non return speed control valve C. The piston cylinders themselves will not be replaced however.

Also a new lay out for the conduits must be established including the integration of pneumatic elements like said speed regulating-quick exhaust valves A1, A2 and B, and non return speed control valve C, the modular manifold MCVC with the single pressure valves SPU and the double pressure valves DPU and including the integration of pressure vessel ACCU.

The existing control valves will be replaced by the modular manifold MVSV where the valves are arranged in a single pressure section SPS and a double pressure section DPS. All valves on the MCVC are connected electrically to the machine control, such as PLC or fieldbus, by a connecting terminal consisting of a housing and a DIN SUB D 25 pole connector for the incoming electrical signals and a 25 pole modular manifold connector to connect said connecting terminal electrically to the rest of the modular manifold MVSV.

Because the valves are rearranged into two sections DPS and SPS they will demand a different sequence of the electric control signals which activate the solenoids because the position of one control valve compared to the other control valves in regard to the incoming electrical signals and in regards to their relative position to the piston cylinders is likely to be changed.

This relocation of the solenoid controlled control valves demands a reprogramming of the electrical control system, PLC or fieldbus, which is obviously costly and will prevent in many cases the application of the energy conserving valve concept.

Because the valves will be rearranged, the electrical connections between the incoming electrical signals from the connecting terminal, and the electrical signals actually going to the solenoids of the control valves must also be rearranged by integrating a switchboard SB thus saving reprogramming the electrical control system. The switchboard is schematically shown in FIG. 7.

This switchboard SB has the same modular mounting system (not shown) and can be easily mounted between the modular manifold MVSV and the connecting terminal. The switch board SB comprises a housing including the modular mounting system (not shown). In said housing is a printed circuit board PCB including a 25 poles multi-pole connector MMD which connects to the multi-pole connector of the connecting terminal when connecting terminal and switchboard SB are mounted together.

Multi-pole connector MMD has a flexible cable FC assembled to each pole. On the end of each flexible cable is a rigid metal pin, connector or otherwise to enable an easy electrical connection to a counterpart connector PRC. Every pole of said 25 pole multi-pole connector MMD is also connected to a row of twenty five light emitting diode LED mounted on the said PCB and marked IN on the housing of the switchboard SB. These LED's are visible on the outside of the switch board housing and identifies the incoming pole on the switchboard SB when the electrical signal on this pole is activated.

The printed circuit board PCB also comprises a pin or connector receiving multi-25 pole connector PRC which can receive the pin or connector or otherwise of the flexible cables coming from Multi-pole connector MMD. In this way the incoming signals from the connecting terminal can be connected to any of the 25 poles on the PRC at will, thus creating the total flexibility to adapt an existing electrical control system going to the modular manifold MVSV.

Said pin receiving multi-pole connector PRC is connected by the printed circuit board PCB to a second row of light emitting diodes LED mounted on the said PCB and marked OUT on the housing of the switchboard SB, which is oriented parallel to the first row of LED's. These LED's are visible on the outside of the switch board and identifies the outgoing pole when the electrical signal on this pole is activated. This way the user can compare the incoming signals in the original pneumatic system control system to the signals going to the modular manifold MVSV with the energy saving valves.

The switch board also comprises a 25 pole multi connector MPMM mounted on said PCB which connects the switch board SB to the modular manifold MVSV. This multi-pole connector MPMM is connected electrically to the pin receiving connector PRC by means of the printed circuit board PCB. This way the electrical circuit is closed between the connecting terminal and the modular manifold MVSV and electrical control signals can be passed on and controlled in position at will.

It will be understood that the number of poles can change depending on the manifold execution. It can furthermore be advantageously to include web based support on method of rewiring and connecting the switchboard.

The present invention is not limited to the embodiment shown, but extends also to other embodiments falling within the scope of the appended claims.

1. A method for operating a pneumatic system comprising at least one pneumatic cylinder, the method comprising:
(a) supplying a first gas under pressure to a pneumatic cylinder for a first stroke, wherein the first stroke is a working stroke of said cylinder, and
(b) providing a second gas under pressure, wherein the pressure of the second gas is lower than the pressure of the first gas,
wherein providing the second gas comprises providing the first gas from the pneumatic cylinder during a second stroke of said pneumatic cylinder.

2. The method according to claim 1, wherein providing the second gas comprises supplying the first gas from the pneumatic cylinder to an accumulator vessel in the second stroke.

3. The method according to claim 1, further comprising supplying the first gas to a pneumatic cylinder for the second stroke, wherein said second stroke is a working stroke, and wherein providing the second gas furthermore comprises providing the first gas from said pneumatic cylinder during the first stroke of said pneumatic cylinder.

4. The method according to claim 1, further comprising supplying the second gas to a pneumatic cylinder for the second stroke, wherein said second stroke is a returning stroke.

5. The method according to claim 4, wherein supplying the second gas comprises supplying the first gas from the pneumatic cylinder to said pneumatic cylinder for the returning stroke.

6. The method according to claim 1, wherein in a working stroke the first gas is supplied to the pneumatic cylinder through a working line, and wherein providing the second gas during the second stroke comprises switching a working valve to at least partially seal of said working line from the pneumatic cylinder to provide the second gas.

7. A pneumatic system comprising:
(a) at least one pneumatic cylinder, wherein the pneumatic cylinder is arranged to perform a first stroke and a second stroke, wherein the first stroke is a working stroke;
(b) at least one first gas source for providing a first gas under pressure;
(c) at least one second gas source for providing a second gas under pressure, wherein the pressure of the second gas is lower than the pressure of the first gas;
(d) at least one switching device for switching the supply of gas to the pneumatic cylinder, wherein the switching device is arranged to supply the first gas to the pneumatic cylinder for the first stroke and to supply the first or the second gas to the pneumatic cylinder for the second stroke, and
(e) at least one working valve, wherein the working valve is arranged to supply the first gas to the pneumatic cylinder in the first stroke and to supply the first gas from the pneumatic cylinder to the second gas source in the second stroke.

8. The pneumatic system according to claim 7, wherein the working valve comprises a speed regulator for regulating the gas flow from said working valve to the switching device while exhausting the first gas to the second gas source.

9. The pneumatic system according to claim 7, wherein the second gas source comprises an accumulating vessel, and wherein the working valve is arranged to supply the first gas from a working stroke of a pneumatic cylinder to the accumulating vessel in the second stroke.

10. The pneumatic system according to claim 7, wherein the switching device comprises a working outlet and a second outlet, wherein the working outlet is arranged to supply the first gas to the pneumatic cylinder in the working stroke and the second outlet is arranged to supply the first or second gas to the pneumatic cylinder in the second stroke, and wherein the working valve is arranged between the working outlet and the pneumatic cylinder.

11. The pneumatic system according to claim 7, wherein the working valve comprises:
(f) a working port arranged for connection with the switching device;
(g) a cylinder port arranged for connection with the cylinder, and
(h) at least one second gas port arranged for connection with the second gas source,
wherein the working valve is arranged to supply gas to the cylinder port upon supply of gas under pressure on the working port and to otherwise supply at least a part of the gas from the cylinder port to the second gas port, and wherein the working valve furthermore comprises a speed regulator for regulating the flow of gas from the cylinder port back to the working port.

12. The pneumatic system according to claim 11, wherein the second gas port comprises a non-return valve.

13. The pneumatic system according to claim 7, wherein the switching device comprises a low pressure switching device arranged to supply the second gas to the pneumatic cylinder in a second stroke, and wherein the second stroke is a returning stroke.

14. The pneumatic system according to claim 13, wherein the second gas source comprises a connecting line, and wherein the working valve is arranged to supply the first gas from the pneumatic cylinder through the connecting line to said pneumatic cylinder for the second stroke.

15. The pneumatic system according to claim 14, further comprising a returning valve, wherein the returning valve is arranged to supply the second gas from said connecting line and the gas from the low pressure switching device to the pneumatic cylinder, and wherein the returning valve comprises a speed regulator for regulating the flow of gas from the pneumatic cylinder through said valve in the first stroke.

16. The pneumatic system according to claim 7, wherein the switching device comprises a high pressure switching device which is arranged to supply the first gas to the pneumatic cylinder in a second stroke, wherein the second stroke is a working stroke, and wherein two working valves are arranged to supply first gas from the working strokes to the second gas source.

17. The pneumatic system according to claim 7, comprising a switching system comprising a plurality of switching devices, preferably at least one low pressure switching device and at least one high pressure switching device, for switching gas to a plurality of pneumatic cylinders.

18. The pneumatic system according to claim 7, further comprising a connection system, wherein the connection system is arranged to connect the pneumatic system to a control terminal arranged to control the pneumatic system, wherein the connection system comprises a plurality of first poles for connection with the pneumatic system for control thereof and a plurality of second poles for connection with the control terminal, and wherein the connection system furthermore comprises at least one connecting device for removable connecting at least one first pole with at least one second pole, wherein the connecting device preferably comprises a conducting wire.

19. (canceled)
